(19) United States
(12) Patent Application Publication
(10) Pub. No.: US 2015/0242392 A1
(43) Pub. Date: Aug. 27, 2015

(54) INTERNATIONAL KEYBOARD FOR IN-CAR COMMUNICATION AND ENTERTAINMENT SYSTEM

(71) Applicant: Ford Global Technologies, LLC, Dearborn, MI (US)

(72) Inventors: Dean Thomas Wisniewski, Detroit, MI (US); Ivette Hernandez, Dearborn, MI (US); Richard Englert, South Lyon, MI (US); Jason Bernard Johnson, Dearborn, MI (US)

(73) Assignee: Ford Global Technologies, LLC, Dearborn, MI (US)

(21) Appl. No.: 14/191,688

(22) Filed: Feb. 27, 2014

(51) Int. Cl. G06F 17/28; G06F 3/02; G06F 3/041

(52) U.S. Cl. CPC G06F 17/28; G06F 3/0416; G06F 3/0227

(57) ABSTRACT

An in-car communication and entertainment system including an international keyboard having a key (e.g., an ABC key) located on a display/screen (e.g., touch screen) enabling a user to toggle through multiple pages of characters, for example accented or special characters associated with a particular language. The key also includes jewels/indicators representing the amount of pages of characters associated with a particular keyboard wherein each jewel or indicator is lit or highlighted to indicate the specific page. Additionally, another key (e.g., a Globe key) enables the user to change the typing language without changing the system language. In this manner, the international keyboard enables users to interface and communicate with the system in a number of different languages.

### BACKGROUND OF THE INVENTION

1. Field of the Invention

The present invention relates generally to in-car communications and entertainment systems, and more particularly to new and improved in-car communication and entertainment systems including an international keyboard that enables users to interface and communicate with the system in a number of different languages/dialects.

2. Description of Related Art

MyFord Touch™ is an in-car communication and entertainment system jointly developed by the Ford Motor Company and Microsoft. Presently, the technology comes factory installed with Ford product offerings and is based, at least in part, on the Microsoft™ Auto 4.0 software platform. The main user interface of the system typically resides in a relatively large (e.g., 8 inch), color touch screen (e.g., LCD based), typically located in a portion of the center console of the passenger cabin, such that it is within relatively easy reach and view of the driver. Additionally, two smaller (e.g., 4.2 inches) screens (e.g., LCD based) may also be provided in the instrument cluster to provide other information/data to the user. One or more manual user controls (e.g., multi-function thumb buttons) may also be provided on the steering wheel, allowing the user to interface with the system without having to take their hands off of the steering wheel.

The features of the system typically include, without limitation: (1) voice-activated commands, e.g., Ford Sync™ technology to control the climate, audio, phone and navigation features in a hands-free manner through the use of only their voice (e.g., on-screen menus accompany voice-activated commands to let the driver see which commands they can use); (2) traffic, directions and information, e.g., visual presentation of Ford Sync™ traffic, directions and information applications; (3) vehicle health reports provide personalized online reports for the vehicle showing vehicle diagnostics, scheduled maintenance and any recall information, and allows users to schedule car service online, directly with the users' preferred car dealer, directly from the personalized online report; (4) 911 Assist, a form of an advanced automatic collision notification system, e.g., when sensors detect the vehicle has been involved in a collision involving airbag deployment and, on certain vehicles, where the emergency fuel pump shut-off is activated, 911 Assist puts the occupant(s) of the car directly in touch with a 911 operator; (5) Internet connectivity provides full Wi-Fi capability and also includes hotspot connectivity enabling other devices to share the MyFord Touch™ system's Internet connection, supports on-screen and USB-connected keyboards, provides RSS feed aggregator and text-to-voice reader, and provides in-car Wi-Fi hot-spot capability through USB mobile broadband modem or USB-installed Aircard; and (6) media features include two USB 2.0 inputs (MyFord Touch™ provides compatibility with USB-connected MP3 players), SD card slot, RCA jack input for audio and video, AM/FM radio, CD player, Sirius™ satellite radio, HD radio capability, Internet media player equipped with new Podcast category, and Bluetooth enhanced data rate audio support.

### SUMMARY OF THE INVENTION

In accordance with the general teachings of the present invention, a new and improved in-car communication and entertainment system is provided.

In accordance with one example of the present invention, the system includes an international keyboard having a key (e.g., referred to as an “ABC key”), located on the display/screen (e.g., touch screen) enabling a user to toggle through multiple pages of characters, for example, accented or special characters associated with a particular language. Located above the ABC key are jewels/indicators representing pages of characters wherein each jewel or indicator is lit or highlighted to indicate a specific page. Additionally, the system may include another key (e.g., referred to as a “Globe key”) enabling the user to change the typing language without changing the system language. In this manner, the international keyboard enables users to interface and communicate with the system in a number of different languages.

In the disclosed example of the in-car communication and entertainment system includes a touch screen display having a keyboard associated with the touch screen display, wherein the keyboard displays a plurality of characters corresponding to a first language or dialect. A key element associated with the keyboard operates such that actuation of the key element causes the touch screen display to display a list of at least one language or dialect other than the first language or dialect. A user may select a language or dialect from the list causing the keyboard to display a plurality of characters corresponding to a second language or dialect.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a default main user interface of an in-car communication and entertainment system, in accordance with a first embodiment of the present invention;

FIG. 2 is a schematic view of an ABC page of a default main user interface of an in-car communication and entertainment system, in accordance with a second embodiment of the present invention;

FIG. 3 is a schematic view of an alternative language selection screen of a main user interface of an in-car communication and entertainment system, in accordance with a third embodiment of the present invention;

FIG. 4 is a schematic view of a first alternative main user interface of an in-car communication and entertainment system wherein French has been chosen as the typing language, in accordance with a fourth embodiment of the present invention;

FIG. 5 is a schematic view of an ABC screen of a second alternative main user interface of an in-car communication and entertainment system wherein Arabic has been chosen as the typing language, in accordance with a fifth embodiment of the present invention;

FIG. 6 is a schematic view of an ABC screen of a third alternative main user interface of an in-car communication and entertainment system wherein Cyrillic has been chosen as the typing language, in accordance with a sixth embodiment of the present invention;

FIG. 7 is a schematic view of a fourth alternative main user interface of an in-car communication and entertainment system wherein Chinese has been chosen as the typing language, in accordance with a seventh embodiment of the present invention;

FIG. 8 is a schematic view of a fifth alternative main user interface of an in-car communication and entertainment system wherein Greek has been chosen as the typing language, in accordance with an eighth embodiment of the present invention;

FIG. 9 is a schematic view of a main destination entry user interface of an in-car communication and entertainment system wherein Simplified Chinese has been chosen as the typing language, in accordance with a ninth embodiment of the present invention;

FIG. 10 is a schematic view of an alternative main destination entry user interface of an in-car communication and entertainment system wherein Traditional Chinese has been chosen as the typing language, in accordance with a tenth embodiment of the present invention; and

FIG. 11 is an illustrative flow diagram of the primary processing steps of the in-car communication and entertainment system, in accordance with an eleventh embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

With respect to accommodation of the cultural expectations and regional (or federal, state, local, as the case may be) government regulations for each export market area, the following general considerations should be taken into account: (1) driving restrictions; (2) text labeling; (3) grammar; (4) abbreviations; (5) truncation; (6) icons; (7) keyboard layout; and/or (8) destination entry guidelines.

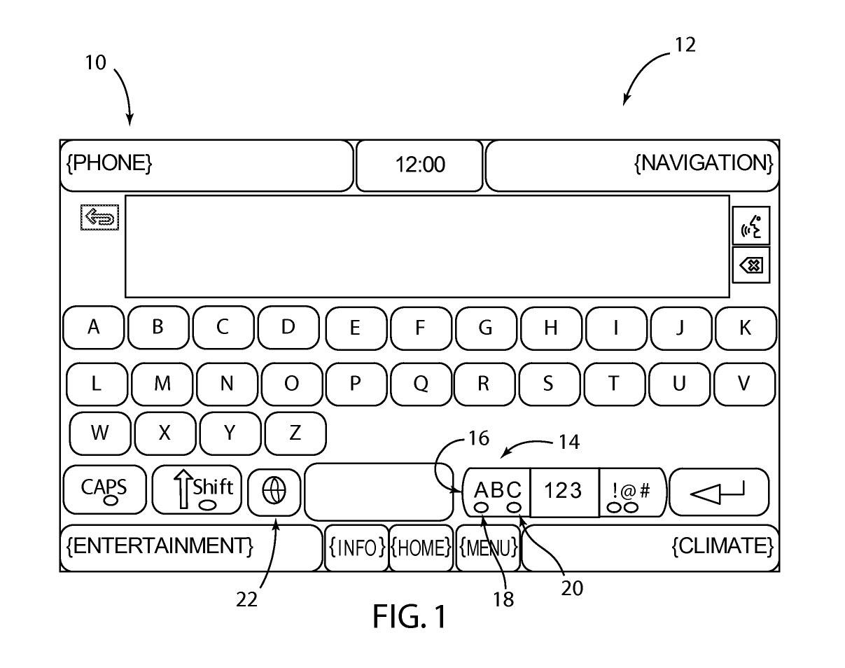

With those considerations in mind, reference is made to FIG. 1 that depicts an illustrative main user interface screen generally shown at 10 of an in-car communication and entertainment system 12. The screen 10 is typically housed in a portion of the center console of the passenger cabin of the vehicle (not shown). In this view, the screen 10 depicts the default language (e.g., the language that was set as the factory default) as being North American English, e.g., as evidenced by a standard twenty-six letter English alphabet keyboard. Depending on the country of manufacture, the intended country of importation, and so forth the default language may vary. Additionally, the layout or configuration of the various elements of the screen 10 may vary. That is, the various elements of the screen 10 may be re-positioned, e.g., relative to one another, or altered in appearance, e.g., in shape, color, size, etc., without affecting the overall function of the system 12.

Still referring to FIG. 1, the screen 10 may include a key 14 referred herein to as an “ABC Key.” The term “ABC” is for reference only and another term or acronym may refer to this particular key. By way of example, the key 14 enables a user to access, e.g., via a toggle mechanism, one or more pages of additional text, characters, symbols and/or the like, that cannot be readily depicted on the screen 10 due to space limitations. In the disclosed example, key 14 can be actuated by the user by pressing, tapping, swiping or otherwise manipulating the key 14.

The ABC key 14 may include a jewel/indicator system 16 that corresponds to the number of pages of additional text, characters, symbols and/or the like available to the user. FIG. 1 shows two jewel elements 18, 20 indicating that there are two pages of additional text, characters, symbols and/or the like that are available to the user. The total number of jewel elements may depend on the language selected by the user. Certain selected languages may require no additional pages of additional text, characters, symbols and/or the like, while other languages may require multiple pages of additional text, characters, symbols and/or the like.

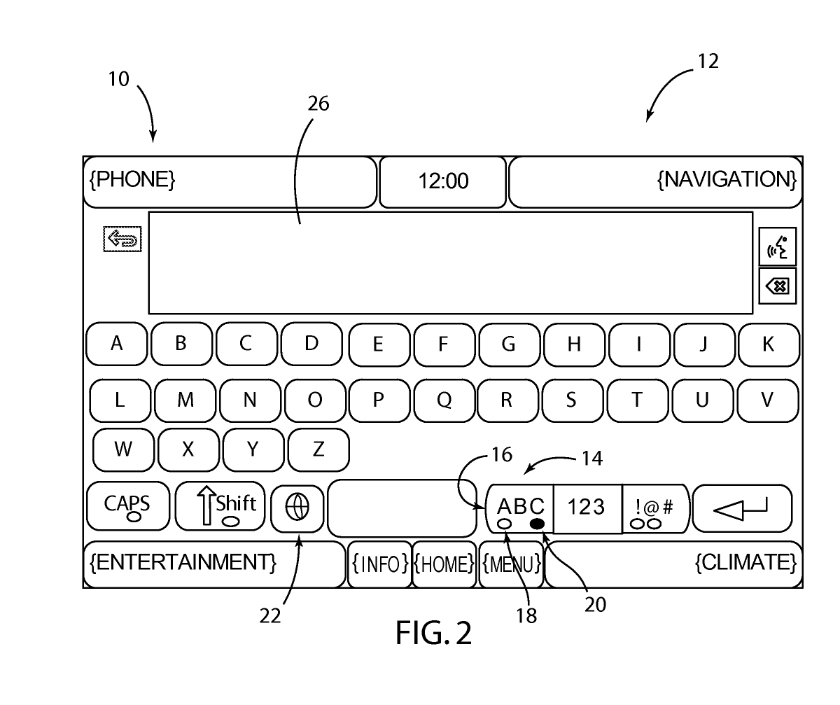

Referring to FIG. 2, the second jewel element 20 is shown highlighted indicating to the user that they are viewing the second page of the additional text, characters, symbols and/or the like. Lighting, darkening, flashing, or otherwise identifying a particular jewel element may also be used to indicate the specific page of additional text, characters, symbols and/or the like currently viewed by the user. Regardless of whether the user is entering text from the main screen 10 or one of the pages of additional text, characters, symbols and/or the like, all text is typically entered into the text box 26. Additional keys and other features generally common to conventional in-car communication and entertainment systems may also be provided to the system 12 of the present invention. Such features may include a phone key, clock, navigation key, entertainment key, climate control key, back key, delete/undo/cancel key, voice activation key, CAPS key, shift key, number page key, symbol page key, enter key, space bar key, info key, home key, menu key, and/or the like.

Referring again to FIG. 1, the screen 10 may include another key 22 referred herein to as a “Globe Key.” The term “Globe” is for reference purposes only and another symbol, term or acronym may refer to this particular key. By way example, the key 22 enables the user to select, e.g., via a toggle mechanism, a different operational language/dialect in which to enter text into the system 12. For example, the toggle mechanism can be actuated by the user by pressing, tapping, swiping or otherwise manipulating the key 22. As used herein “operational language/dialect” includes the language/dialect of the system viewable and/or enterable by the user of the system 12 at any given time. The user may wish to change the default language/dialect of the system 12 for any number of valid reasons, such as the default language/dialect of the system 12 not being the user's native language. Only the entry language/dialect, i.e., the language/dialect available to the user to type in characters into various text entry fields, as well as the label language/dialect of one or more text entry fields, would be changed in this manner. The underlying language/dialect that was used to initially create the software program that operates the system would not change. For example, if English was used to initially create the software program that performs the steps outlined herein, and the default language/dialect set by the factory was English, changing the operational language/dialect to Italian, for example, would have no effect on varying or altering the language/dialect of the software program and/or the default language/dialect of the system 12 as well.

By way of example, the main languages/dialects that may be used to enter text into the system may include, without limitation, North American English, North American Spanish, Canadian French, South American Portuguese, United Kingdom English, German, Russian, Turkish, Polish, European French, European Spanish, Italian, Swedish, European Portuguese, Dutch, Australian English, Mandarin Chinese, Taiwanese Chinese, Japanese, Arabic, Korean, Danish, Norwegian and combinations thereof. However, it should also be appreciated that any language/dialect may be practiced with the present invention.

Several languages/dialects by their very nature and complexity require availability of one or more pages of additional text, characters, symbols and/or the like in order for the user to enter text into the system, e.g., to get destination directions or send text messages. These additional pages of additional text, characters, symbols and/or the like may be collectively referred to as “character sets.” Character sets that may be used to enter additional text into the system may include, without limitation, Greek, Latvian, Lithuanian, Ukrainian, Slovakian, Hungarian, Romanian, Finnish, Belarussian, Czech, Slovak, Latin, Cyrillic, Hebrew, Simplified Chinese, Traditional Chinese, Japanese, Korean and combinations thereof.

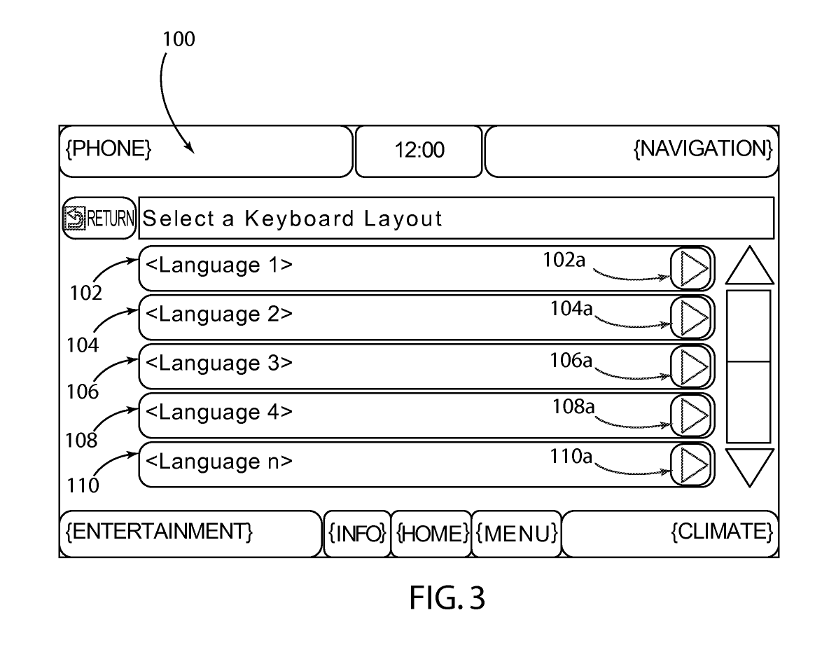

Referring to FIG. 3, there is shown a screen 100, wherein the key 22 (shown in FIGS. 1-2) has already been actuated, a mechanism for the user to change the default language/dialect of the system 12. Below the banner entitled “Select a Keyboard Layout” there is a plurality of language/dialect keys 102, 104, 106, 108, 110, respectively. Each of these keys would represent a different language/dialect selected from the list of languages/dialects set forth above. Although the languages/dialects are assigned numbers in this view the actual names of the language/dialect would be provided in the key label. If there are more language/dialect options available than can fit on a single screen, there may be provided an up/down scroll bar that enables the user to quickly and easily go through all of the available language/dialect options to find those that are of most interest. Although there are only five language/dialect options shown in this view many different languages/dialects may be used with the present invention. Once the user finds a language/dialect they want to select as the new operational language of the system 12, he/she would simply press the key 102, 104, 106, 108, 110, associated with each particular language/dialect.

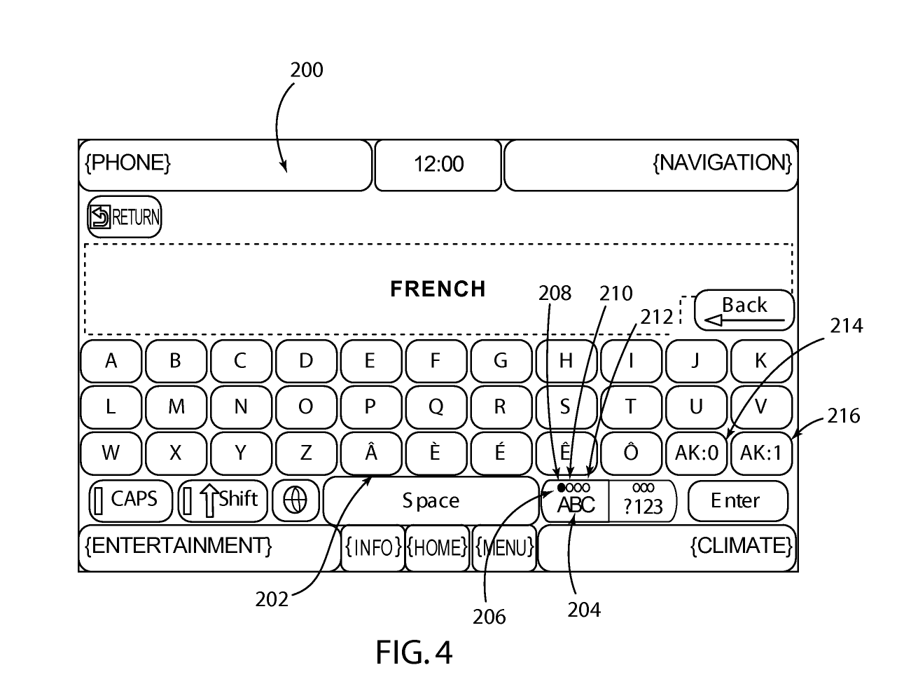

Referring to FIG. 4, there is shown an illustrative screen 200, wherein one of the language/dialect keys (shown in FIG. 3) corresponding to French has been selected. In this view, a “French-based” keyboard 202 is displayed on the screen 200, evidenced by the presentation of various accented letters, including those found commonly in connection with the letters a, e and o. Additionally, in this view it should be noted, that unlike FIGS. 1-2, there is shown a jewel/indicator system 204 that displays that there are four jewel elements 206, 208, 210, 212, respectively, indicating that there are four additional pages of additional text, characters, symbols and/or the like. Again, as with the embodiment shown in FIGS. 1-2, an indication of which specific page of additional text, characters, symbols and/or the like is being currently viewed by the user can be provided by lighting, darkening, flashing, or otherwise highlighting the corresponding jewel element. FIG. 4 further illustrates application keys AK:0 214 and AK:1 216. Application keys 214, 216 are used with specific applications, that is different applications may be presented to the user depending upon the specific screen. For example, the application keys 214, 216 change dynamically depending upon whether the user is entering text for navigation destination entry/address book entry or text messaging/web browser/email. Further, application keys 214, 216 appear only if the main screen for the selected language has room for them.

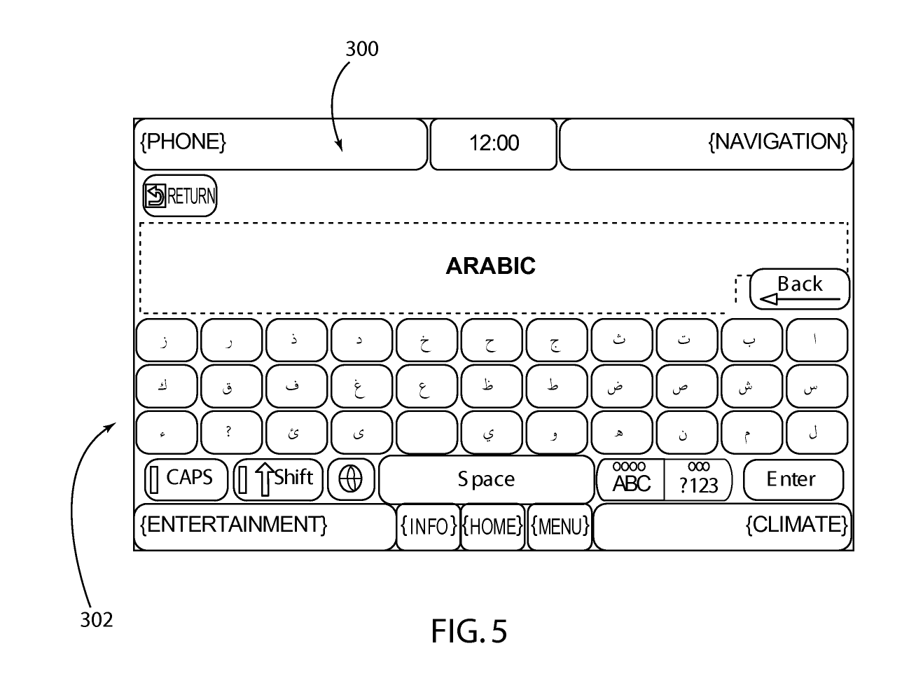

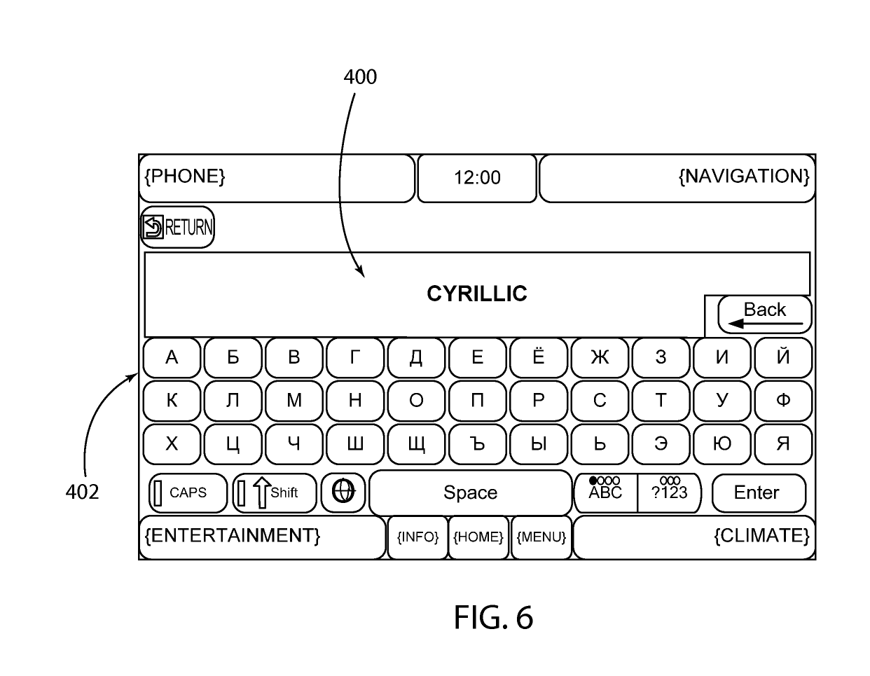

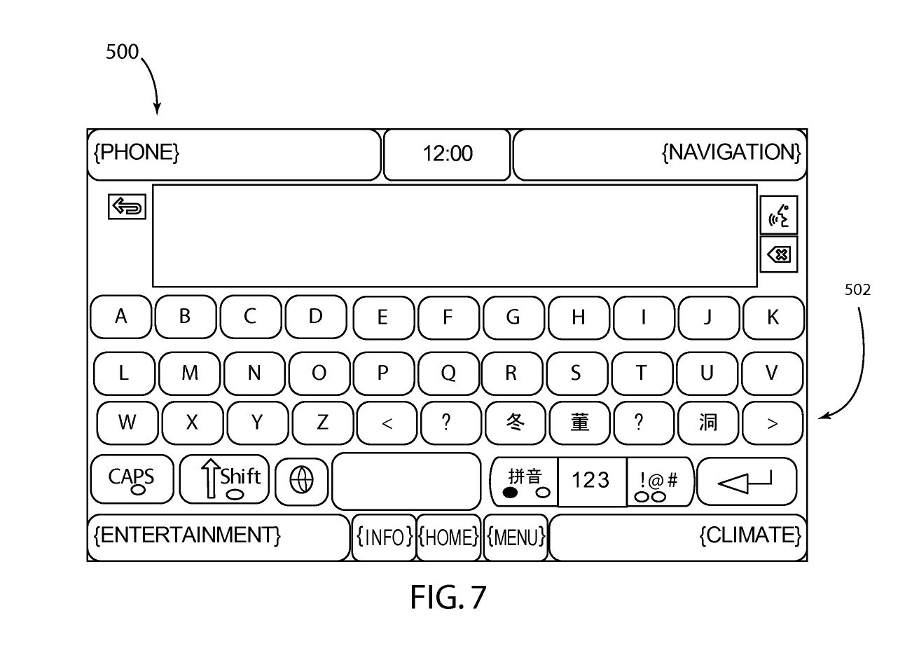

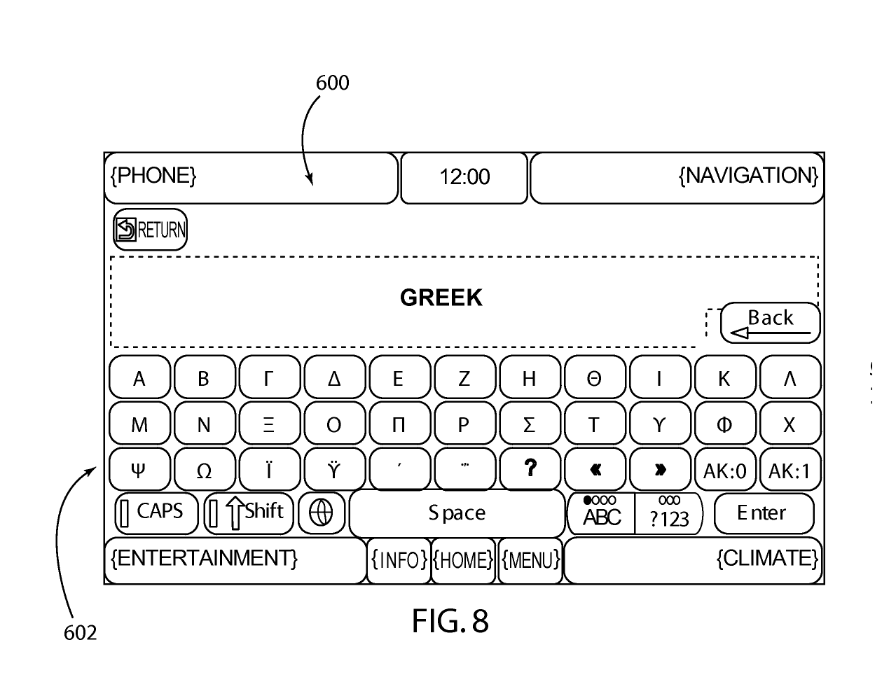

FIG. 5-8 illustrate the versatility of the present invention in connection with non-Western languages; specifically, FIG. 5 illustrates an ABC screen 300 depicting a keyboard 302 with several Arabic characters, FIG. 6 illustrates an ABC screen 400 depicting a keyboard 402 with several Cyrillic characters, FIG. 7 illustrates a main screen 500 depicting a keyboard 502 with several Chinese characters, and FIG. 8 which illustrates a main screen 600 depicting a keyboard 602 with several Greek characters. Again, as with the previously described embodiments, an indication of which specific page of additional text, characters, symbols and/or the like is being currently viewed by the user can be provided by lighting, darkening, flashing, or otherwise highlighting the corresponding jewel element.

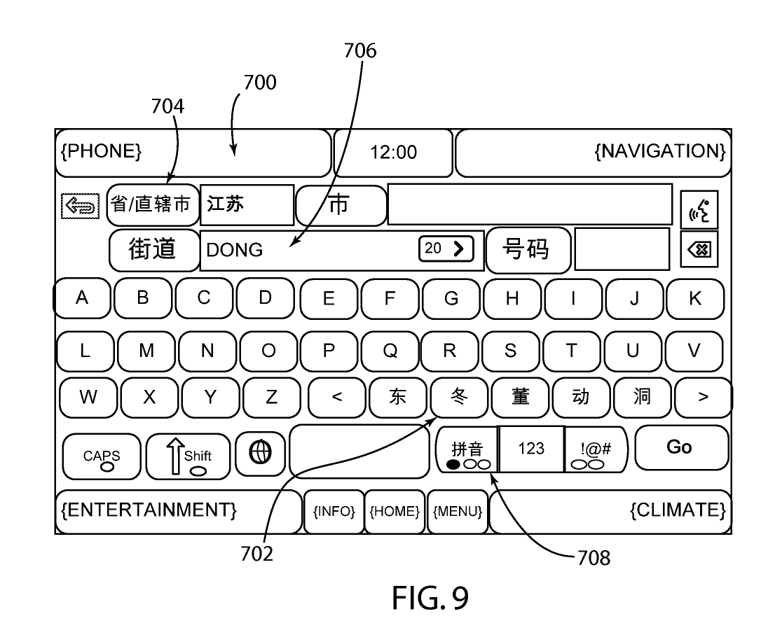

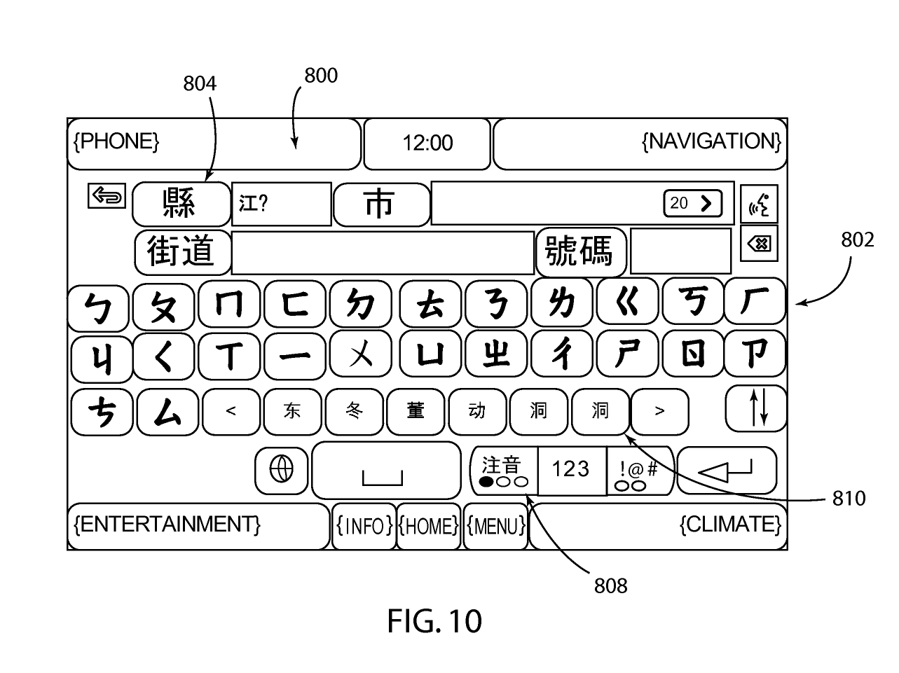

The present invention may also be used in conjunction with destination entry applications, e.g., to receive driving instructions to a specific address, in the language/dialect of the user's choosing. Referring to FIG. 9, there is illustrated a destination entry screen 700 depicting not only a keyboard 702 with characters in Simplified Chinese, but several of the text fields 704 are also labeled in Simplified Chinese. FIG. 9 also illustrates an input method key 708 that accesses several input method screens. Referring to FIG. 10, there is illustrated a destination entry screen 800 depicting not only a keyboard 802 with characters in Traditional Chinese, but several of the text fields 804 are also labeled in Traditional Chinese. Again, as with the previously described embodiments, an indication of which specific page of additional text, characters, symbols and/or the like is being currently viewed by the user can be provided by lighting, darkening, flashing, or otherwise highlighting the corresponding jewel element. FIG. 10 illustrates an up and down arrow key 806 used to manually move between two pages of standard characters for the selected input method. As with the previous example, an input method key 808 accesses several input method screens. In addition, a candidate character selection row 810 is based on user input and may be displayed on either one or both pages of standard characters for the selected input method. As the user types, smart or fuzzy logic displays candidate characters thereby shortening what the user needs to input. The user presses the respective candidate character key from the candidate character selection row 810 to appropriately populate the text box the user can continue typing for additional candidate characters or press the enter key when finished. Adjacent candidate characters can be accessed by the “<” and “>” character keys. If there are no candidate characters than no character selection buttons would be shown. If one or more characters are present in the number of candidate buttons shown matches a number of candidate characters and the“<” and “>” character keys are not used. If nine or more candidate characters are associated with the user input then both the“<” and “>” character keys are shown with six candidate characters between them and the candidate list wraps.

The system 12 also has the capability of being able to “toggle” back and forth among several different languages/dialects within the same text entry screen. For example, the user may feel comfortable changing the default language/dialect from English to Chinese such that the labels on the text entry fields are now in Chinese. However, the user may then decide he/she feels more comfortable entering the actual text into those fields in English, as opposed to Chinese (or perhaps a companion of the user that does not understand Chinese is tasked with entering the text). Thus “hybrid” user interface screens, i.e., having two or more languages/dialects represented therein, are possible with the present invention (e.g., see text entry 706 in FIG. 9 discussed above).

In some applications, the present invention may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device. Examples of a computing device may include, but are not limited to, an automotive vehicle computer system, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof.

The computer device may also include an input device. In one example, a user of the computer device may enter commands and/or other information into computer device via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to a bus via any of a variety of interfaces including, but not limited to, a serial interface, a parallel interface, a game port, a USB interface, a FIREWIRE interface, a direct interface to a bus, and any combinations thereof. The input device may include a touch screen interface that may be a part of or separate from the display.

A user may also input commands and/or other information to the computer device via a storage device (e.g., a removable disk drive, a flash drive, etc.) and/or a network interface device. A network interface device may be utilized for connecting the computer device to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device via a network interface device.

The computer device may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

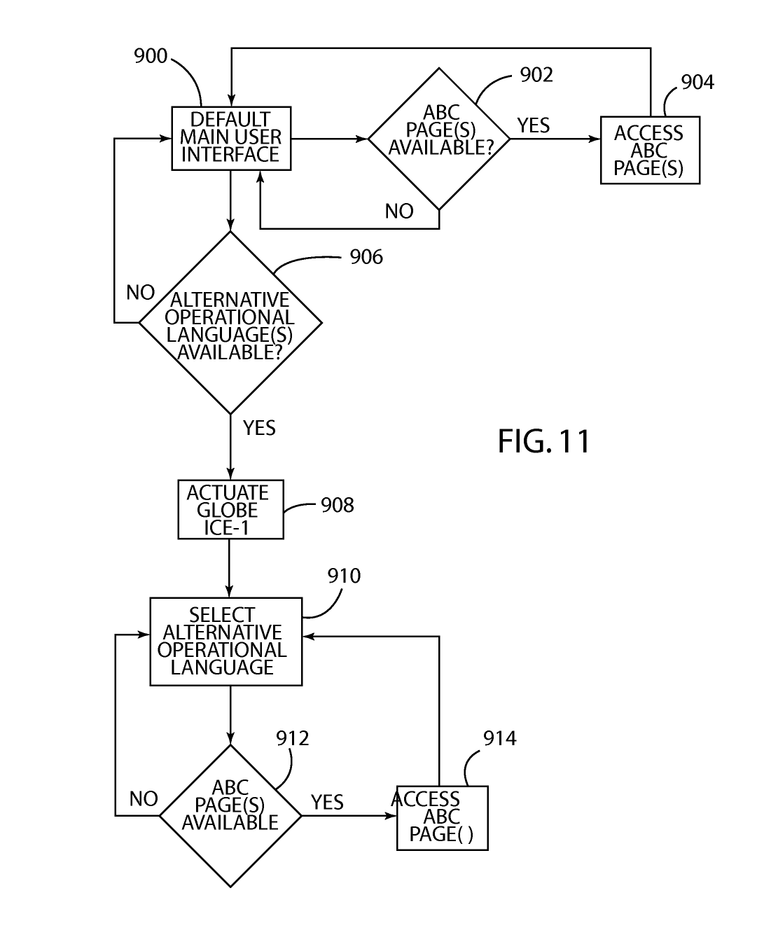

The implementation of the system can be accomplished in any number of ways, including a computer-implemented system and/or method configured to carry out a specific sequence of steps and/or procedures to accomplish a specific sequence of functions and/or features. FIG. 11 shows an illustrative flowchart depicting the primary processing steps for carrying out one or more embodiments of the present invention.

At step 900, the user encounters a default main user interface screen. If the user only needs to use the characters on the default main user interface screen, then no action needs to be taken by the user to change the default language/dialect and the user can immediately begin typing or otherwise entering text into the system, e.g., via a text entry field.

Step 902 indicates whether one or more ABC page(s) are provided for the default language/dialect. The system can be pre-programmed to only load (or indicate to the user via the ABC key) specific ABC page(s) compatible with the default language/dialect. If there are no ABC page(s) for the default language/dialect the user is limited to those characters contained on the default main user interface screen.

At step 904 the user is provided access to those characters located in one of the ABC page(s). The user accesses a desired ABC page(s) by actuating the ABC key, locates the desired character on the screen, and then enters that character into the system via a text entry field. The user can return to step 900 after finishing with the particular ABC page(s).

Step 906 provides an indication of whether one or more additional “new” or “alternative” operational languages/dialects are available to the user other than the default language/dialect.

If the user intends to change the default language/dialect of the main user interface screen the user actuates the Globe key at step 908. The user may then scroll through available operational languages/dialects and select the desired operational language/dialect at step 910. If the user only needs to use the characters on the “new” main user interface screen, then no action needs to be taken by the user to change the “new” operational language/dialect and the user can immediately begin typing or otherwise entering text into the system via a text entry field.

Step 912 provides an indication of whether one or more ABC page(s) are provided for the “new” operational language/dialect. The system can be pre-programmed to only load (or indicate to the user via the ABC key) those specific ABC page(s) that are compatible with the “new” operational language/dialect. If there are no ABC page(s) for the “new” operational language/dialect, the user may use only those characters contained on the “new” main user interface screen.

At step 914 the user is provided access to those characters provided on one or more ABC pages for the “new” operational language/dialect. If the user intends to access characters that are located in one of the ABC page(s) the user would access the ABC page(s) by actuating the ABC key, locate the desired character on the screen, and enter that character into the system via a text entry field. The user can then return to step 910 after finishing with the particular ABC page(s).

It should also be appreciated that the user can navigate back and forth between a default language/dialect user interface and a “new” language/dialect user interface by simply actuating an appropriate key such as a back key, go key, enter key, home key and/or the like.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An in-car communication and entertainment system, comprising:
a touch screen display;
a keyboard operably associated with the touch screen display, wherein the keyboard displays a plurality of characters corresponding to a first language or dialect; and
a key element operably associated with the keyboard;
wherein actuation of the key element causes the touch screen display to display a list of at least one language or dialect other than the first language or dialect;
wherein a user is selectively operable to select a language or dialect from the list so as to cause the keyboard to display a plurality of characters corresponding to a second language or dialect.

2. The system according to claim 1, wherein the user is selectively operable to enter characters corresponding to the first or second language or dialect into a text entry field of the touch screen display.

3. The system according to claim 1, wherein the first or second language is selected from the group consisting of North American English, North American Spanish, Canadian French, South American Portuguese, United Kingdom English, German, Russian, Turkish, Polish, European French, European Spanish, Italian, Swedish, European Portuguese, Dutch, Australian English, Mandarin Chinese, Taiwanese Chinese, Japanese, Arabic, Korean, Danish, Norwegian and combinations thereof.

4. The system according to claim 1, further comprising:
a second key element operably associated with the keyboard;
wherein the second key element indicates a presence of a character set corresponding to the first or second language or dialect.

5. The system according to claim 4, wherein the character set is selected from the group consisting of Greek, Latvian, Lithuanian, Ukrainian, Slovakian, Hungarian, Romanian, Finnish, Belarussian, Czech, Slovak, Latin, Cyrillic, Hebrew, Simplified Chinese, Traditional Chinese, Japanese, Korean and combinations thereof.

6. The system according to claim 4, wherein the second key element includes indicia corresponding to a number of pages comprising the character set.

7. An in-car communication and entertainment system, comprising:
a touch screen display;
a keyboard operably associated with the touch screen display, wherein the keyboard displays a plurality of characters corresponding to a first language or dialect; and
a key element operably associated with the keyboard;
wherein the key element indicates a presence of a character set corresponding to the first language or dialect.

8. The system according to claim 7, wherein the character set is selected from the group consisting of Greek, Latvian, Lithuanian, Ukrainian, Slovakian, Hungarian, Romanian, Finnish, Belarussian, Czech, Slovak, Latin, Cyrillic, Hebrew, Simplified Chinese, Traditional Chinese, Japanese, Korean and combinations thereof.

9. The system according to claim 7, wherein the key element includes indicia corresponding to a number of pages comprising the character set.

10. The system according to claim 7, further comprising:
a second key element operably associated with the keyboard;
wherein actuation of the second key element causes the touch screen display to display a list of at least one other language or dialect;
wherein a user is selectively operable to select a second language or dialect from the list so as to cause the keyboard to display a plurality of characters corresponding to a second language or dialect.

11. The system according to claim 10, wherein the user is selectively operable to enter characters corresponding to the first or second language or dialect into a text entry field of the touch screen display.

12. The system according to claim 10, wherein the first or second language is selected from the group consisting of North American English, North American Spanish, Canadian French, South American Portuguese, United Kingdom English, German, Russian, Turkish, Polish, European French, European Spanish, Italian, Swedish, European Portuguese, Dutch, Australian English, Mandarin Chinese, Taiwanese Chinese, Japanese, Arabic, Korean, Danish, Norwegian and combinations thereof.

13. The system according to claim 10, wherein the key element indicates a presence of a character set corresponding to the second language or dialect.

14. The system according to claim 13, wherein the character set is selected from the group consisting of Greek, Latvian, Lithuanian, Ukrainian, Slovakian, Hungarian, Romanian, Finnish, Belarussian, Czech, Slovak, Latin, Cyrillic, Hebrew, Simplified Chinese, Traditional Chinese, Japanese, Korean and combinations thereof.

15. The system according to claim 10, wherein the key element includes indicia corresponding to a number of pages comprising the character set of the second language or dialect.

16. An in-car communication and entertainment system, comprising:
a touch screen display;
a keyboard operably associated with the touch screen display, wherein the keyboard displays a plurality of characters corresponding to a first language or dialect;
a first key element operably associated with the keyboard;
wherein actuation of the first key element causes the touch screen display to display a list of at least one language or dialect other than the first language or dialect;
wherein a user is selectively operable to select a language or dialect from the list so as to cause the keyboard to display a plurality of characters corresponding to a second language or dialect; and
a second key element operably associated with the keyboard;
wherein the second key element indicates a presence of a character set corresponding to the second language or dialect.

17. The system according to claim 16, wherein the user is selectively operable to enter characters corresponding to the first or second language or dialect into a text entry field of the touch screen display.

18. The system according to claim 16, wherein the first or second language is selected from the group consisting of North American English, North American Spanish, Canadian French, South American Portuguese, United Kingdom English, German, Russian, Turkish, Polish, European French, European Spanish, Italian, Swedish, European Portuguese, Dutch, Australian English, Mandarin Chinese, Taiwanese Chinese, Japanese, Arabic, Korean, Danish, Norwegian and combinations thereof.

19. The system according to claim 16, wherein the character set is selected from the group consisting of Greek, Latvian, Lithuanian, Ukrainian, Slovakian, Hungarian, Romanian, Finnish, Belarussian, Czech, Slovak, Latin, Cyrillic, Hebrew, Simplified Chinese, Traditional Chinese, Japanese, Korean and combinations thereof.

20. The system according to claim 16, wherein the second key element includes indicia corresponding to a number of pages comprising the character set.
